(19) United States
(12) Patent Application Publication
(10) Pub. No.: US 2024/0229908 A1
(43) Pub. Date: Jul. 11, 2024

(54) APPARATUS GENERATING TORQUE AND OPERATING METHOD THEREOF

(71) Applicant: INDUSTRY-ACADEMIC COOPERATION FOUNDATION, CHOSUN UNIVERSITY, Gwangju (KR)

(72) Inventor: Hyeon Jae LEE, Gwangju (KR)

(73) Assignee: INDUSTRY-ACADEMIC COOPERATION FOUNDATION, CHOSUN UNIVERSITY, Gwangju (KR)

(21) Appl. No.: 18/613,504

(22) Filed: Mar. 22, 2024

Related U.S. Application Data
(63) Continuation of application No. PCT/KR2022/013019, filed on Aug. 31, 2022.

(30) Foreign Application Priority Data
Sep. 23, 2021 (KR) 10-2021-0125757

(51) Int. Cl. F16H 33/10

(52) U.S. Cl. CPC F16H 33/10

(57) ABSTRACT

The present disclosure relates to a power generation apparatus that generates torque and a method of operating the power generation apparatus. According to an embodiment, the power generation apparatus includes: at least a pair of control moment gyroscopes generating torque in different directions; and a unidirectional driving module outputting torque generated in different directions by the at least a pair of control moment gyroscopes in a predetermined direction.

### CROSS REFERENCE TO RELATED APPLICATION

The present application is a continuation of International Patent Application No. PCT/KR2022/013019, filed on Aug. 31, 2022, which claims priority to Korean Patent Applications No. 10-2021-0125757, filed on Sep. 23, 2021, the entire contents of which are incorporated herein for all purposes by this reference.

### BACKGROUND

### Technical Field

The present disclosure relates to a power generation apparatus and a method of operating the power generation apparatus. In more detail, the present disclosure relates to a power generation apparatus using a control moment gyroscope module and a method of operating the power generation apparatus.

### Description of the Related Art

Motors and internal combustion engines have been developed as apparatuses for generating torque and transmitting power. A motor that is a representative apparatus for generating power by generating torque in the related art uses a method of generating torque that depends on variation of angular acceleration.

However, a motor, an internal combustion engine, etc. that are representative apparatuses for generating torque in the related art has a limitation of using a large amount of energy to generate torque. Accordingly, it is required to develop a technology for generating large torque even while consuming a small amount of power.

### PRIOR ART DOCUMENT

### Patent Document

(Patent Document 1) Korean Patent No. 1695524

### SUMMARY

According to an embodiment, a power generation apparatus for generating torque and a method of operating the power generation apparatus may be provided.

In more detail, a power generation apparatus that generates torque in a predetermined direction using at least a pair of control moment gyroscopes generating torques in different directions, and a method of operating the power generation apparatus may be provided.

As a technical means for achieving the objectives described above, according to an embodiment of the present disclosure, a power generation apparatus that generates torque may include: at least a pair of control moment gyroscopes generating torque in different directions; and a unidirectional driving module outputting torque generated in different directions by the at least a pair of control moment gyroscopes in a predetermined direction.

According to an embodiment, the pair of control moment gyroscopes may be synchronized to each other and symmetrically operated.

According to an embodiment, it is possible to generate large torque using a small amount of power.

According to an embodiment, it is possible to generate torque in a predetermined direction by controlling the directions of torque of control moment gyroscopes.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a view illustrating the torque generation principle of a power generation apparatus using a pair of control moment gyroscopes according to an embodiment of the present disclosure;

FIG. 2 is a view illustrating the structure of a control moment gyroscope according to an embodiment of the present disclosure;

FIG. 3 is a view illustrating torque profiles that are generated by a single control moment gyroscope and a pair of control moment gyroscopes;

FIG. 4 is a view illustrating the structure of a power generation apparatus according to an embodiment and torque variation before and after passing through a unidirectional driving module;

FIG. 5 is a view illustrating the structure and operation of a power generation apparatus according to another embodiment;

FIG. 6 is a view illustrating the structure and operation of a power generation apparatus according to another embodiment;

FIG. 7 is a view illustrating the structure and operation of a power generation apparatus according to another embodiment; and

FIG. 8 is a view illustrating the structure and operation of a power generation apparatus according to another embodiment.

### DETAILED DESCRIPTION

Terminologies used herein were selected as terminologies that are currently used as generally as possible in consideration of the functions herein, but may be changed, depending on the intention of those skilled in the art, precedents, or advent of a new technology. Further, there are terminologies selected by applicant(s) at the applicant(s)' opinion in specific cases, and in these cases, the meanings will be described in the corresponding parts. Accordingly, the terminologies used herein should be defined on the basis of the meanings of the terminologies and the entire specification, not simply the names of the terminologies.

Throughout the present specification, unless explicitly described otherwise, “comprising” any components will be understood to imply the inclusion of other components rather than the exclusion of any other components. Further, the terms “˜ part”, “module”, and the like mean a unit for processing at least one function or operation and may be implemented by hardware or software or by a combination of hardware and software.

Example embodiments of the present disclosure will be described in detail with reference to the accompanying drawings for those skilled in the art to be able to easily implement he present disclosure. However, the present disclosure may be modified in various different ways and is not limited to the example embodiments described herein. Further, in the accompanying drawings, components irrelevant to the description will be omitted in order to obviously describe the present invention, and similar reference numerals will be used to describe similar components throughout the specification.

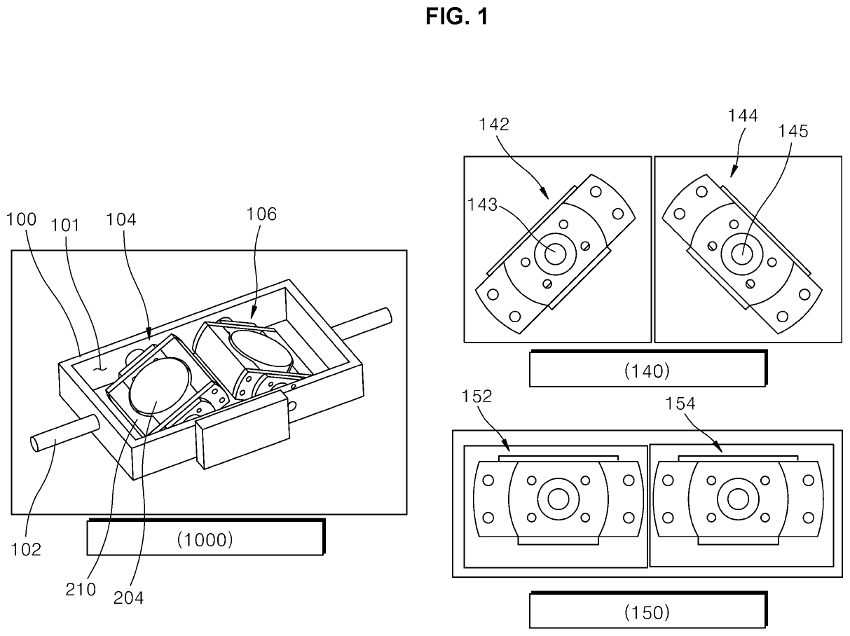

FIG. 1 is a view illustrating the torque generation principle of a power generation apparatus using a pair of control moment gyroscopes according to an embodiment of the present disclosure.

According to an embodiment, a power generation apparatus can generate power using at least a pair of control moment gyroscopes. For example, a power generation apparatus may include a frame 100 having a torque shaft and a first control moment gyroscope 104 and a second control moment gyroscope 106 that are installed in the frame 100 and generate predetermined torque. However, the present disclosure is not limited to the above example and a power generation apparatus 1000 may further include a plurality of pairs of control moment gyroscopes.

According to an embodiment, the power generation apparatus 1000 can generate torque having a predetermined direction. In more detail, the power generation apparatus 1000 can generate torque about one shaft (e.g., a torque shaft) using at least a pair of control moment gyroscopes.

Further, the power generation apparatus 1000 can also generate torque about one shaft using at least a pair of synchronized control moment gyroscopes 104 and 106 and a unidirectional driving module. According to another embodiment, the power generation apparatus 1000 can also generate high torque about a predetermined shaft by disposing a plurality of control moment gyroscope groups each including at least a pair of control moment gyroscopes along a predetermined shaft.

Meanwhile, referring to “140” in FIG. 1, a power generation apparatus according to an embodiment includes a frame 100 having a torque shaft 102 and first and second control moment gyroscopes 142 and 144 that generate torque in different directions.

The frame 100 has an installation space 101 in which in which the first and second control moment gyroscopes 142 and 144 are rotatably installed and the torque shaft 102 is installed on an end thereof. It is preferable that the installation space 101 is open on the top and bottom. In this configuration, the first and second control moment gyroscopes 142 and 144 are installed inside the frame 100 to be rotatable in the installation space 101.

The picture 150 in FIG. 1 shows the state in which the pair of control moment gyroscopes 142 and 144 have been rotated a predetermined angle. The first control moment gyroscope 142 and the second control moment gyroscope 144 shown in the picture 140 may correspond to the first control moment gyroscope 152 and the second control moment gyroscope 154 shown in “150”, respectively. In this configuration, the first control moment gyroscope 142 and the second control moment gyroscope 144 can generate torque in different directions while rotating in different directions on gimbal shafts 243 and 245, respectively.

The pair of control moment gyroscopes 142 and 144 that generates torque in different directions is synchronized symmetrically with respect to the gimbal shafts 143 and 146, whereby the power generation apparatus can also generate torque about one torque shaft 102. The power generation apparatus 1000 has high torque generation efficiency in comparison to motors that generate power using electricity, and can effectively generate torque using a small amount of power in comparison to existing batteries, so the power generation apparatus 1000 has the advantage of very high energy efficiency.

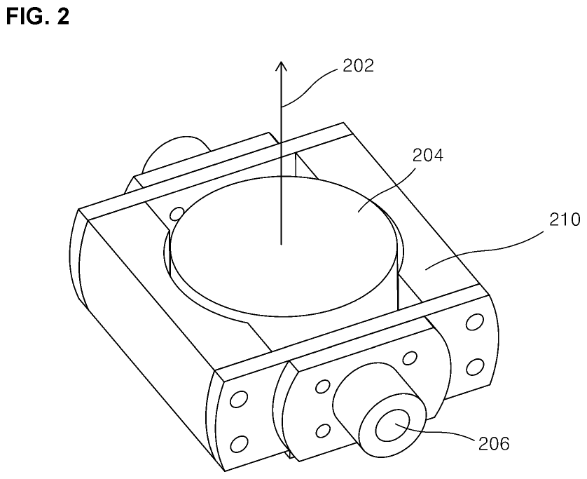

FIG. 2 is a view illustrating the structure of a control moment gyroscope according to an embodiment of the present disclosure.

Referring to the figure, the control moment gyroscope 142, 144 has a gyroscope body 210 installed on the frame 100 and rotating on a gimbal shaft 206 extending in a direction crossing the longitudinal direction of the torque shaft 102, a rotor 204 installed on the gyroscope body 210 to rotate on a spin shaft 202, and a spin motor (not shown) rotating the rotor 204 on the spin shaft 202.

The rotor 204 is installed on the gyroscope body 210 to extend in the direction in which the spin shaft 202 is perpendicular to the gimbal shaft 206. In this configuration, it is preferable that the rotor 204 has a circular cross-section. The control moment gyroscope 142, 144 is installed such that the gimbal shaft 206 is perpendicular to the torque shaft 102, and rotates on the gimbal shaft 206. In this configuration, it is preferable that the pair of first and second control moment gyroscopes 142 and 144 is installed to rotate in different directions on the gimbal shaft 206. However, the present disclosure is not limited to the above example and may include other configurations that generate angular moment and rotate it.

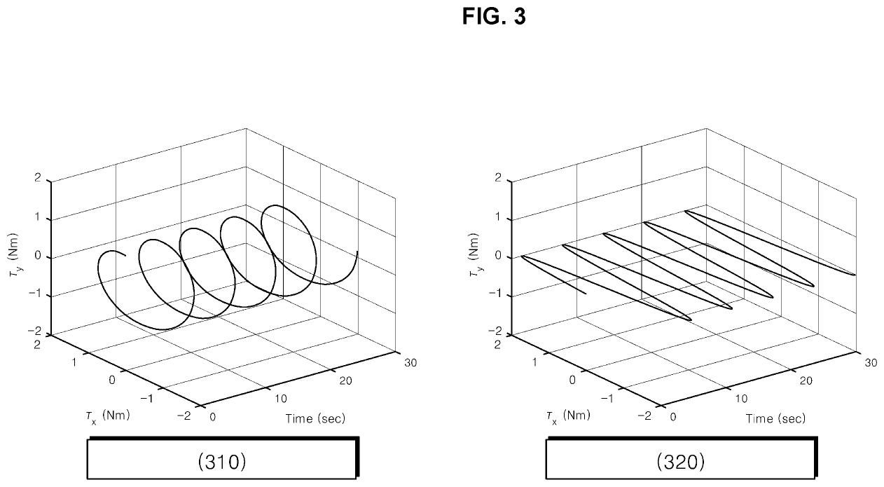

FIG. 3 is a view illustrating torque profiles that are generated by a single control moment gyroscope and a pair of control moment gyroscopes.

The picture 310 in FIG. 3 shows a torque profile that is generated by one control moment gyroscope and the picture 320 shows a torque profile that is generated by a pair of synchronized control moment gyroscopes. Referring to picture 310, it can be seen that the torque profile that is generated by one control moment gyroscope shows torque variation in a plane and torque in the torque profile that is generated by a pair of synchronized control moment gyroscopes used by the power generation apparatus according to the present disclosure has directionality with respect to one axial direction.

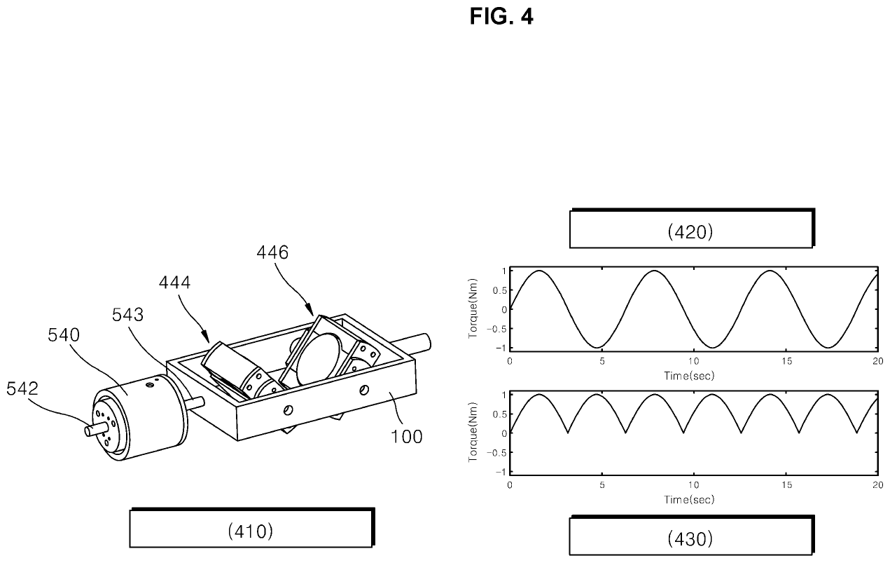

FIG. 4 is a view illustrating the structure of a power generation apparatus according to an embodiment and torque variation before and after passing through a unidirectional driving module.

Referring to the picture 410, the structure of a power generation apparatus 1000 according to an embodiment is shown. The power generation apparatus 1000 according to an embodiment may include at least a pair of control moment gyroscopes 444 and 446. However, the present disclosure is not limited the example shown in FIG. 4, the power generation apparatus 1000 may include more pairs of control moment gyroscopes.

The power generation apparatus 1000 may include at least a pair of control moment gyroscopes and a unidirectional driving module 540. The unidirectional driving module 540 can acquire torque generated in different directions by the pair of control moment gyroscopes 444 and 446 and can output the torque while changing the directions of the acquired torque into one direction. The unidirectional driving module 540 can output unidirectional torque with respect to one output shaft 542.

For example, at least a pair of control moment gyroscopes can be controlled to be synchronized and operated symmetrically to each other by the power generation apparatus 1000 (e.g., a processor in the power generation apparatus). At least a pair of control moment gyroscopes that are synchronized and operated in accordance with an embodiment can generate torque in different directions.

The unidirectional driving module 540 according to the present disclosure can change the torque of control moment gyroscopes generating torque in different directions in at least a pair of control moment gyroscopes into one direction. The power generation apparatus 1000 according to the present disclosure can change the torque generated in different directions by at least a pair of synchronized control moment gyroscopes into one direction using the unidirectional driving module 540, and can output the torque changed into one direction through one output shaft 542. That is, the unidirectional driving module 540 is connected to a torque shaft 543 of the frame 100, thereby receiving torque generated by the control moment gyroscopes 444 and 446 through the torque shaft 543 and outputting the torque to the output shaft 542.

Further, according to an embodiment, the power generation apparatus 1000 may further include a unidirectional driving module connected to at least a pair of control moment gyroscope modules, a torque shaft 413 connected to a first end of the unidirectional driving module, and an output shaft 542 connected to a second end of the unidirectional driving module and connected with a power demand apparatus. Referring to the pictures 420 and 430, a torque profile generated by least a pair of control moment gyroscopes and a torque profile converted using a unidirectional driving module are shown, respectively. According to an embodiment, the torque profile generated by at least a pair of control moment gyroscopes may not have consistent directionality because a positive direction and a negative direction are alternately generated with respect to an axis (based on a torque value 0). However, torque changed by a unidirectional driving module and output through the output shaft 542, as shown in the picture 430, may be shown as having consistent directionality (e.g., a half-wave rectification type).

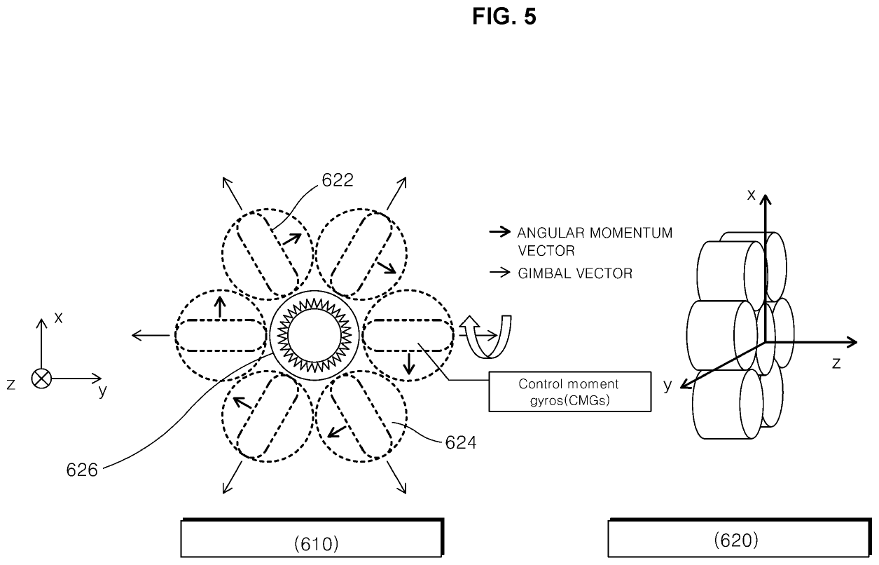

FIG. 5 is a view illustrating the structure and operation of a power generation apparatus according to another embodiment.

A power generation apparatus 1000 according to another embodiment may include a pair of control moment gyroscopes 622 and 625. According to an embodiment, the control moment gyroscopes 622 and 625 can rotate on control moment gyroscope shafts (gimbal shafts) perpendicular to torque shafts, respectively. According to an embodiment, the power generation apparatus 1000 may include three pairs of control moment gyroscopes, but is not limited thereto.

According to an embodiment, the three pairs of control moment gyroscopes may be arranged in a ring shape around a predetermined center shaft 626. However, the positions of the pairs of control moment gyroscopes are not limited and the power generation apparatus may include pairs of control moment gyroscopes at certain positions adjacent to a predetermined shaft.

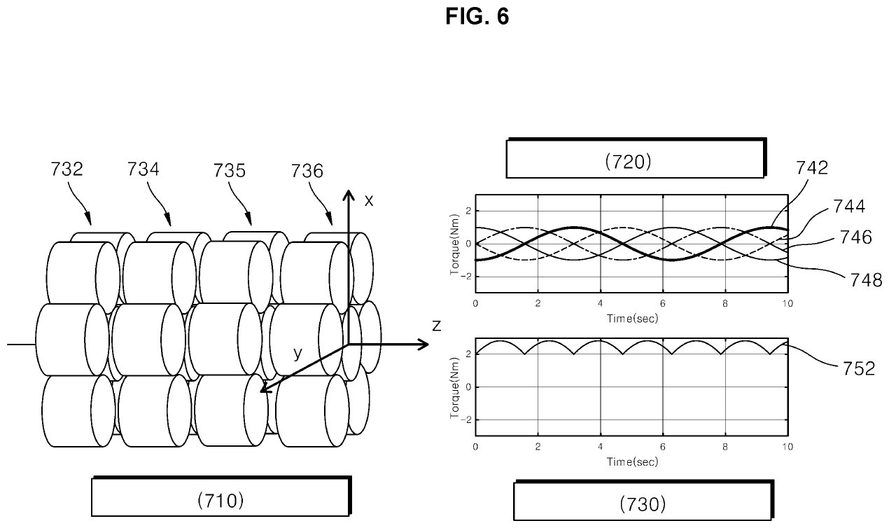

The pairs of control moment gyroscopes in the power generation apparatus 1000 according to an embodiment may make one control moment gyroscope group 620. The power generation apparatus 1000 may include a plurality of control moment gyroscope groups including at least a pair of control moment gyroscopes and can generate more strong torque using the plurality of control moment gyroscope groups. An example of a power generation apparatus 1000 including a plurality of control moment gyroscope groups is described in detail with reference to FIG. 6.

FIG. 6 is a view illustrating the structure and operation of a power generation apparatus according to another embodiment.

Referring to the picture 710, a power generation apparatus 1000 may include a plurality of control moment gyroscope groups 732, 734, 735, and 736 including at least a pair of control moment gyroscopes. According to an embodiment, a plurality of control moment gyroscope groups may be arranged with preset intervals along a predetermined axis (e.g., a z axis or a torque reference axis).

For example, the control moment gyroscope groups 732, 734, 735, and 736 can generate torque profiles 742, 744, 746, and 748, respectively, shown in the picture 720. The torque generated in the control moment gyroscope groups may be shown as torque profiles having different phases. The power generation apparatus 1000 can generate larger torque having predetermined directionality, as in the torque profile shown in the picture 730, by synchronizing torque generated by a plurality of the control moment gyroscope groups.

In more detail, the power generation apparatus 1000 can generate resultant torque 752 over critical torque in a predetermined direction by adding up torque 742, 744, 746, and 748 having different phases and generated in a plurality of control moment gyroscope groups, respectively.

The control moment gyroscope shafts that are the rotation references of pairs of control moment gyroscopes in the power generation apparatus 1000 according to the present disclosure may be perpendicular to the direction of a torque shaft, but they are not limited thereto.

According to an embodiment, the positions of the gimbal shafts that are rotation references of pairs of control moment gyroscopes in the power generation apparatus 1000 are not limited, but the gimbal shafts of the pairs of control moment gyroscopes may be provided perpendicularly to a torque shaft.

Further, according to an embodiment, at least a pair of control moment gyroscopes may be arranged in a ring shape around a predetermined reference shaft. Further, according to an embodiment, at least a pair of control moment gyroscopes is disposed along a reference shaft, thereby being able to form one control moment gyroscope group.

According to an embodiment, a control moment gyroscope group can generate torque in a predetermined direction while rotating around a reference shaft. A power generation apparatus may generate larger torque in one direction using torque that is generated in a plurality of control moment gyroscope groups. The gimbal shafts of the at least one pair of control moment gyroscopes described above may be positioned in different planes and at different heights while being perpendicular to a torque shaft, but even in this case, the gimbal shaft of each of the control moment gyroscopes may be provided perpendicularly to a torque shaft. A plurality of pairs of control moment gyroscopes having gimbal shafts provided perpendicularly to the torque shaft can form a control moment gyroscope group.

A unidirectional driving module can change torque having different directions into a predetermined direction and output the torque from at least a pair of control moment gyroscopes. According to an embodiment, a unidirectional driving module can acquire torque that is transmitted in different directions and can change the torque having different directions into one direction. The unidirectional driving module can transmit the torque changed into one direction to a power demand apparatus.

A gear module (not shown) may be connected to a unidirectional driving module. For example, a power generation apparatus according to an embodiment may include a plurality of unidirectional driving modules connected to pairs of control moment gyroscopes, respectively, and may further include a gear module connected to the plurality of unidirectional driving modules. The gear module (not shown) can generate resultant torque of one direction over critical torque by adding up torque of one direction having different phases and output from the unidirectional driving module.

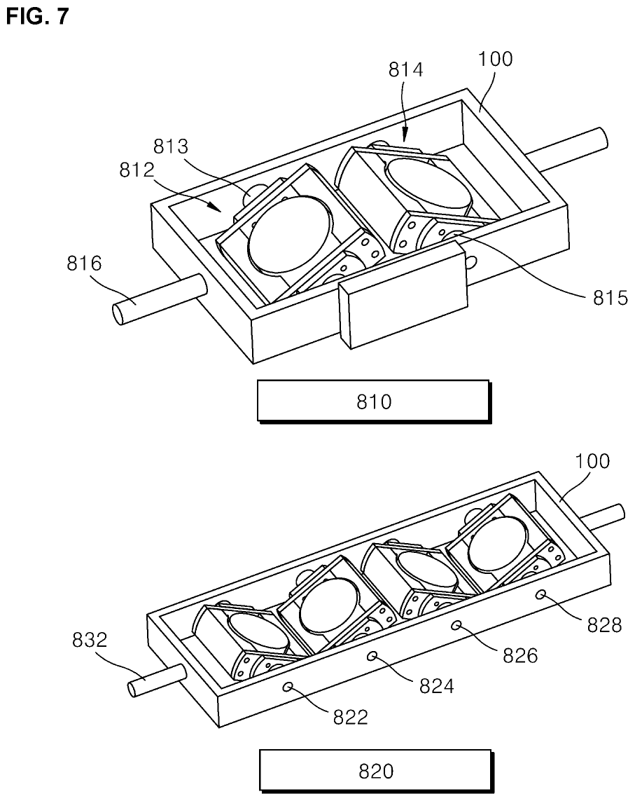

FIG. 7 is a view illustrating the structure and operation of a power generation apparatus according to another embodiment.

According to an embodiment, a power generation apparatus 1000, as shown in the picture 810, may include a pair of control moment gyroscopes. The pair of control moment gyroscopes may include a control moment gyroscope 812 and a control moment gyroscope 814. The control moment gyroscope 812 can rotate in a first direction with respect to a gimbal shaft 813 and the control moment gyroscope 814 can rotate in a second direction that is different from the first direction with respect to a gimbal shaft 815.

The power generation apparatus 1000 controls gimbal motors in the pair of control moment gyroscopes, thereby being able to control control moments such that the control moment gyroscope 812 and the control moment gyroscope 814 generate torque in different directions. The power generation apparatus 1000 can change torque having different directions and generated by the control moment gyroscope 812 and the control moment gyroscope 814 into one direction using a unidirectional driving module, and can output the torque changed into one direction.

According to another embodiment, a power generation apparatus 1000, as shown in the picture 820, may include two pairs of control moment gyroscopes. The two pairs of control moment gyroscopes can rotate on gimbal shafts, respectively, which are provided perpendicularly to a torque shaft 832. However, the present disclosure is not limited to the examples of the pictures 810 and 820, the power generation apparatus 1000 may further include a plurality of pairs of control moment gyroscopes including gimbal shafts perpendicular to a torque shaft.

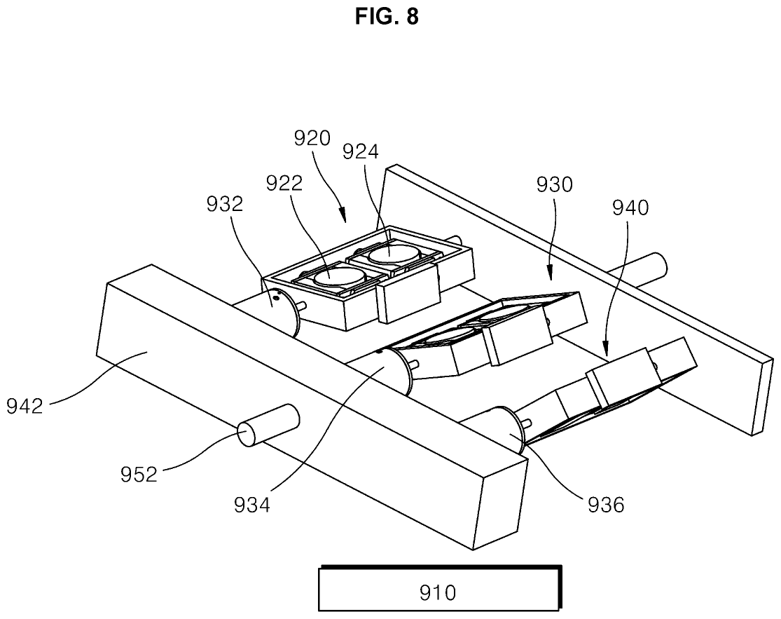

FIG. 8 is a view illustrating the structure and operation of a power generation apparatus according to another embodiment.

According to an embodiment, a power generation apparatus 1000 may include at least a pair of control moment gyroscopes 920, 930, and 940. According to an embodiment, the pair of control moment gyroscopes 920 may include a control moment gyroscope 922 and a control moment gyroscope 924.

According to an embodiment, torque having different directions and output from the pairs of control moment gyroscopes 920, 930, and 940 can be changed into unidirectional torque by unidirectional driving modules 932, 934, and 936 connected to first ends of the pairs of control moment gyroscopes 920, 930, and 940, respectively. According to an embodiment, the torque output by the unidirectional driving modules 932, 934, and 936 has one direction but may be torque having different phases.

According to an embodiment, the power generation apparatus 1000 may further include a gear module 942 connected to the unidirectional driving modules 932, 934, and 936. The gear module 942 acquires unidirectional torque having different phases and adds up the unidirectional torque having different phases, thereby being able to output resultant torque through a gear shaft 952. According to an embodiment, the power generation apparatus 1000 can generate large torque over critical torque using the gear module 942 connected to the unidirectional driving modules 932, 934, and 936.

The method of controlling at least a pair of control moment gyroscopes to generate torque by means of the power generation apparatus 1000 according to an embodiment may be implemented in the types of program commands that can be executed through various computer devices, and recorded on computer-readable media. The computer-readable media may include program commands, data files, and data structures individually or in combinations thereof. The program commands that are recorded on the media may be those specifically designed and configured for the present invention or may be those available and known to those engaged in computer software in the art.

The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter etc. Although embodiments of the present disclosure were described above in detail, the spirit of the present disclosure is not limited thereto and the present disclosure may be changed and modified in various ways on the basis of the basic concept without departing from the scope of the present disclosure described in the following claims.

What is claimed is:

1. A power generation apparatus comprising:
a frame having a torque shaft;
at least a pair of control moment gyroscopes installed in the frame and generating torque in different directions; and
a unidirectional driving module connected to the torque shaft and changing and outputting torque generated in different directions by the control moment gyroscopes into predetermined one direction,
wherein the control moment gyroscopes each include:
a gyroscope body installed on the frame and rotating on a gimbal shaft extending in a direction crossing a longitudinal direction of the torque shaft;
a rotor installed on the gyroscope body to rotate on a spin shaft extending in a direction crossing the gimbal shaft; and
a spin motor rotating the rotor on the spin shaft.

2. The power generation apparatus of claim 1, wherein the pair of control moment gyroscopes is synchronized to each other and symmetrically operated.
